(19) United States
(12) Patent Application Publication
(10) Pub. No.: US 2026/0100158 A1
(43) Pub. Date: Apr. 9, 2026

(54) PIXEL, DISPLAY DEVICE INCLUDING THE SAME, AND ELECTRONIC DEVICE

(71) Applicant: Samsung Display Co., Ltd., Yongin-Si (KR)

(72) Inventors: Dae Sik LEE, Yongin-si (KR); Myeong Su KIM, Yongin-si (KR)

(21) Appl. No.: 19/231,992

(22) Filed: Jun. 9, 2025

(30) Foreign Application Priority Data
Oct. 8, 2024 (KR) 10-2024-0136878

(51) Int. Cl. G09G 3/3233; G09G 3/32

(52) U.S. Cl. CPC G09G 3/3233; G09G 3/32; G09G 2300/0819; G09G 2300/0852; G09G 2310/08; G09G 2320/0257; G09G 2330/021

(57) ABSTRACT

A pixel includes a first transistor having a first electrode receiving a first power voltage and controlling an amount of a driving current, a second transistor having a first electrode connected to a data line and receiving a data voltage from the data line when the second transistor is turned on, and a light emitting element emitting light with a luminance in response to the amount of the driving current. The first power voltage is provided in a pulse width modulation method in which a duty ratio of each of a plurality of pulses gradually increases during a modulation period from a time point when the second transistor is turned off to a time point when the second transistor is turned on again.

This application claims priority to Korean Patent Application No. 10-2024-0136878, filed on Oct. 8, 2024, and all the benefits accruing therefrom under 35 U.S.C. § 119, the content of which in its entirety is herein incorporated by reference.

### BACKGROUND

### 1. Field

The present disclosure relates to a pixel, a display device including the same, and an electronic device.

### 2. Description of the Related Art

As information technology advances, the importance of a display device, which is a connection medium between a user and information, has increased. Accordingly, the use of a display device such as a liquid crystal display device and an organic light emitting display device is increasing.

Various methods have been proposed to reduce power consumption of the display device. For example, the display device may be driven in a mode that displays only minimum information during a period when a user does not use the display device. In this mode, power consumption may be further reduced by displaying an image frame at a low frequency.

Various abnormal display issues such as an afterimage, a luminance decrease, and flickering may occur when displaying an image at a low frequency.

### SUMMARY

Embodiments of the present disclosure provide a pixel, a display device including the pixel, and an electronic device capable of minimizing the abnormal display even though driven at a low frequency.

According to an embodiment of the present disclosure, a pixel includes a first transistor having a first electrode receiving a first power voltage and controlling an amount of a driving current, a second transistor having a first electrode connected to a data line and receiving a data voltage from the data line when the second transistor is turned on, and a light emitting element emitting light with a luminance in response to the amount of the driving current. The first power voltage may be provided in a pulse width modulation method in which a duty ratio of each of a plurality of pulses gradually increases during a modulation period from a first time point when the second transistor is turned off to a second time point when the second transistor is turned on again.

The first power voltage may include a first voltage level that turns on the light emitting element and a second voltage level that turns off the light emitting element. During the modulation period, a first period when the first power voltage has the first voltage level near the first time point may be shorter than a second period when the first power voltage has the first voltage level near the second time point.

During the modulation period, a first width of a pulse having the first voltage level near the first time point may be shorter than a second width of a pulse having the first voltage level near the second time point.

During the modulation period, a width of each of the plurality of pulses having the first voltage level may be the same as each other. A time interval between two pulses near the first time point may be longer than a time interval between two pulses near the second time point.

The first power voltage may include first pulses each having a first width as the first voltage level and a second pulse having a second width as the first voltage level. The second width may be greater than the first width. During the modulation period, as the duty ratio increases, time intervals between the first pulses may be decreased. A last pulse of the modulation period may be the second pulse.

While the second transistor receives the data voltage, a voltage level of the first power voltage may be maintained.

While the second transistor receives the data voltage, the first power voltage may have the first voltage level.

While the second transistor receives the data voltage, the first power voltage may have the second voltage level.

During the modulation period, a voltage level of the first power voltage may be linearly changed.

During the modulation period, a voltage level of the first power voltage may be changed in a stepped manner.

According to an embodiment of the disclosure, a display device includes a plurality of pixels, and a power supply configured to provide a first power voltage to the pixels. Each of the pixels may include a first transistor having a first electrode receiving the first power voltage and controlling an amount of a driving current, a second transistor having a first electrode connected to a data line and receiving a data voltage from the data line when the second transistor is turned off, and a light emitting element configured to emit light with a luminance in response to the amount of the driving current. The power supply may provide the first power voltage in a constant voltage level during a first period from a time point when the second transistor is turned off to a time point when the second transistor is turned on again, in a first mode, and the power supply may provide the first power voltage in a pulse width modulation method in which a duty ratio of each of a plurality of pulses gradually increases during a second period from a first time point when the second transistor is turned off to a second time point when the second transistor is turned on again, in a second mode. The second period may be longer than the first period.

The first power voltage may include a first voltage level that turns on the light emitting element and a second voltage level that turns off the light emitting element. During the second period, a third period when the first power voltage has the first voltage level near the first time point may be shorter than a fourth period when the first power voltage has the first voltage level near the second time point.

During the second period, a first width of a pulse having the first voltage level near the first time point may be shorter than a second width of a pulse having the first voltage level near the second time point.

During the second period, a width of each of the plurality of pulses having the first voltage level may be the same as each other. A time interval between two pulses near the first time point may be longer than a time interval between two pulses near the second time point.

The first power voltage may include first pulses each having a first width as the first voltage level and a second pulse having a second width as the first voltage level. The second width may be greater than the first width. During the second period, as the duty ratio increases, time intervals between the first pulses are decreased. A last pulse of the second period is the second pulse.

While the second transistor receives the data voltage, a voltage level of the first power voltage may be maintained.

While the second transistor receives the data voltage, the first power voltage may have the first voltage level.

While the second transistor receives the data voltage, the first power voltage may have the second voltage level.

During the second period, a voltage level of the first power voltage may be linearly changed.

During the second period, a voltage level of the first power voltage may be changed in a step shape.

According to an embodiment of the disclosure, an electronic device includes a processor to provide an image signal, and a display device to display an image based on the image signal. The display device may include a plurality of pixels, and a power supply configured to provide a first power voltage to the pixels. Each of the pixels may include a first transistor having a first electrode receiving the first power voltage and controlling an amount of a driving current, a second transistor having a first electrode connected to a data line and receiving a data voltage from the data line when the second transistor is turned on, and a light emitting element configured to emit light with a luminance in response to the amount of the driving current. The power supply may provide the first power voltage in a constant voltage level during a first period from a time point when the second transistor is turned off to a time point when the second transistor is turned on again, in a first mode. The power supply may provide the first power voltage in a pulse width modulation method in which a duty ratio of each of a plurality of pulses gradually increases during a second period from a time point when the second transistor is turned off to a time point when the second transistor is turned on again, in a second mode. The second period may be longer than the first period.

A pixel according to the disclosure, a display device including the same, and an electronic device may minimize abnormal display even when driven at a low frequency.

### BRIEF DESCRIPTION OF THE DRAWINGS

The above and other features of the present disclosure will become more apparent by describing in further detail exemplary embodiments thereof with reference to the accompanying drawings.

FIG. 1 is a block diagram illustrating a display device according to an embodiment of the disclosure.

FIG. 2 is a circuit diagram illustrating a pixel and a sensing channel according to an embodiment of the disclosure.

FIG. 3 is a waveform diagram during a display period according to an embodiment of the disclosure.

FIG. 4 is a waveform diagram during a threshold voltage sensing period of a transistor according to an embodiment of the disclosure.

FIG. 5 is a waveform diagram during a mobility sensing period according to an embodiment of the disclosure.

FIG. 6 is a waveform diagram during a threshold voltage sensing period of a light emitting diode according to an embodiment of the disclosure.

FIG. 7 is a timing diagram illustrating a first mode and a second mode according to an embodiment of the disclosure.

FIG. 8 is a timing diagram illustrating a first mode and a second mode according to an embodiment of the disclosure.

FIGS. 9 to 11 are drawings illustrating a second mode according to an embodiment of the disclosure.

FIG. 12 is a timing diagram illustrating a first mode and a second mode according to an embodiment of the disclosure.

FIGS. 13 and 14 are drawings illustrating a case where a slew rate is applied to a voltage level change of a first power voltage.

FIG. 15 is a block diagram of an electronic device according to embodiments of the disclosure.

### DETAILED DESCRIPTION OF THE EMBODIMENT

Hereinafter, embodiments of the present disclosure will be described in detail with reference to the accompanying drawings in order for those skilled in the art to easily implement the present disclosure. The present disclosure may be implemented in various different forms and is not limited to the embodiments described herein.

In order to clearly describe the embodiments of the present disclosure, parts that are not related to the description are omitted, and the same or similar elements are denoted by the same reference numerals throughout the specification. Therefore, the same reference numerals may be used in different drawings to identify the same or similar elements.

The size and thickness of each element shown in the drawings are arbitrarily shown for better understanding and for convenience of description, and thus the present disclosure is not necessarily limited to those shown in the drawings. In the drawings, the thickness may be exaggerated to clearly illustrate various layers and areas.

In the present disclosure, an expression “the same” may mean not only “exactly same” but also “substantially the same”. That is, it may be considered identical to the extent that those skilled in the art would perceive it as the same. Other expressions may be understood as implicitly including the term “substantially”.

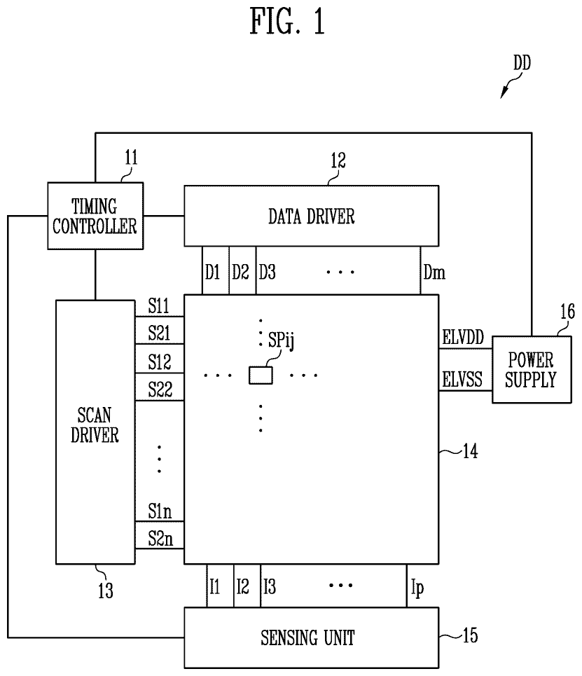

FIG. 1 is a block diagram illustrating a display device according to an embodiment of the present disclosure.

Referring to FIG. 1, the display device DD according to an embodiment of the disclosure may include a timing controller 11, a data driver 12, a scan driver 13, a pixel unit 14, a sensing unit 15, and a power supply 16.

The timing controller 11 may receive input grayscales and control signals for each frame (for example, an image frame) from a processor. Here, the processor may correspond to at least one of a graphics processing unit (GPU), a central processing unit (CPU), an application processor (AP), or the like.

The timing controller 11 may convert the input grayscales to generate output grayscales. For example, the timing controller 11 may generate the output grayscales by converting the input grayscales using sensing data provided by the sensing unit 15. Compensation using the sensing data may compensate for variations in the electrical characteristics of pixel circuits.

The timing controller 11 may provide the output grayscales to the data driver 12. In addition, the timing controller 11 may provide control signals controlling the operation of each of the data driver 12, the scan driver 13, the sensing unit 15, and the power supply 16.

In a display period, the data driver 12 may generate data voltages to be provided to data lines D1, D2, D3, . . . , and Dm using the output grayscales and the control signals received from the timing controller 11. For example, the data driver 12 may sample the output grayscales using a clock signal and convert the sampled output grayscales into the data voltages. The data driver 12 may apply the data voltages to the data lines D1 to Dm in a pixel row unit. Here, m may be an integer greater than 0, and the pixel row refers to pixels connected to the same scan line. In a sensing period, the data driver 12 may supply reference voltages to the data lines D1 to Dm.

The scan driver 13 may receive a clock signal, a scan start signal, or the like from the timing controller 11, and generate first scan signals to be provided to first scan lines S11, S12, . . . , and S1n and second scan signals to be provided to second scan lines S21, S22, . . . , and S2n. Here, n may be an integer greater than 0.

For example, the scan driver 13 may sequentially supply first scan signals having a turn-on level to the first scan lines S11 to S1n. In addition, the scan driver 13 may sequentially supply second scan signals having a turn-on level to the second scan lines S21 to S2n. For example, the scan driver 13 may include a first scan driver connected to the first scan lines S11 to S1n and a second scan driver connected to the second scan lines S21 to S2n. Each of the first scan driver and the second scan driver may include scan stages configured in a form of a shift register. Each of the first scan driver and the second scan driver may generate a scan signal, and the generated scan signal may be output to the first scan lines S11 to S1n and the second scan lines S21 to S2n, respectively. The generated scan signal may be transferred to a next stage of the first scan driver or the second scan driver, and may be served as a scan start signal, which has a turn-on level, of the next stage according to control of a clock signal.

In the display period, the sensing unit 15 may supply an initialization voltage to sensing lines I1, I2, I3, . . . , and Ip. Here, p may be an integer greater than 0. In the sensing period, the sensing unit 15 may receive sensing voltages from the sensing lines I1 to Ip connected to pixels.

The sensing unit 15 may include sensing channels connected to the sensing lines I1 to Ip. For example, the sensing lines I1 to Ip and the sensing channels may correspond to each other on a one to one basis. For example, the number of the sensing lines I1 to Ip and the number of the sensing channels may be the same. However, the present disclosure is not limited thereto. For example, the number of the sensing channels may be less than the number of the sensing lines I1 to Ip. At this time, the sensing unit 15 may further include demultiplexers to perform sensing operation of the pixels in a time-division manner.

The pixel unit 14 includes the pixels. Each pixel SPij may be connected to corresponding data line, scan line, and sensing line. The power supply 16 may provide a first power voltage ELVDD and a second power voltage ELVSS which are commonly applied to the pixels. However, the present disclosure is not limited thereto. For example, the power supply 16 may provide different first power voltages ELVDD for each pixel row.

According to an embodiment, at least two or more of the timing controller 11, the data driver 12, the scan driver 13, the pixel unit 14, the sensing unit 15, and the power supply 16 may be configured as an integrated chip (IC). The separation or integration of each functional units shown in FIG falls within the scope of the modifications that can be easily made by those skilled in the art. Therefore, a detailed description of all possible modifications is omitted.

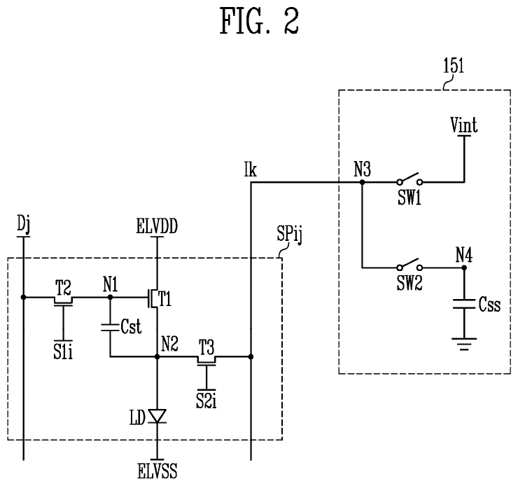

FIG. 2 is a circuit diagram illustrating a pixel and a sensing channel according to an embodiment of the disclosure.

The pixel SPij may include transistors T1, T2, and T3, a storage capacitor Cst, and a light emitting element LD.

The transistors T1, T2, and T3 may be configured as N-type transistors. However, the present disclosure is not limited thereto. For example, the transistors T1, T2, and T3 may be configured as P-type transistors. For example, the transistors T1, T2, and T3 may be configured as a combination of an N-type transistor and a P-type transistor. The P-type transistor collectively refers to a transistor in which an amount of conducting current increases when a voltage difference between a gate electrode and a source electrode increases in a negative direction. The N-type transistor collectively refers to a transistor in which an amount of conducting current increases when a voltage difference between a gate electrode and a source electrode increases in a positive direction. A transistor may be configured in various forms such as a thin film transistor (TFT), a field effect transistor (FET), or a bipolar junction transistor (BJT).

The first transistor T1 may have a gate electrode connected to a first node N1, a first electrode connected to a first power voltage ELVDD, and a second electrode connected to a second node N2. The first transistor T1 may control an amount of a driving current, and may be referred to as a driving transistor.

The second transistor T2 may have a gate electrode connected to a first scan line S1i, a first electrode connected to a data line Dj, and a second electrode connected to the first node N1. The second transistor T2 may receive the data voltage from the data line Dj and transfers the data voltage to the first node N1 when the second transistor T2 is turned on.

The third transistor T3 may have a gate electrode connected to a second scan line S2i, a first electrode connected to the second node N2, and a second electrode connected to a sensing line Ik.

The storage capacitor Cst may have a first electrode connected to the first node N1 and a second electrode connected to the second node N2.

The light emitting element LD may have an anode electrode connected to the second node N2 and a cathode electrode receiving a second power voltage ELVSS. The light emitting element LD may emit light of a first color, a second color, or a third color. For example, the first color may be one color among red, green, and blue, the second color may be one color other than the first color among red, green, and blue, and the third color may be a remaining color other than the first color and the second color among red, green, and blue. In addition, magenta, cyan, and yellow may be used instead of red, green, and blue as the first to third colors.

The light emitting element LD may be a light emitting diode. The light emitting element LD may be configured as an organic light emitting element (organic light emitting diode), an inorganic light emitting element (inorganic light emitting diode), a quantum dot/well light emitting element (quantum dot/well light emitting diode), or the like. According to an embodiment, only one light emitting element LD is provided in each pixel, but the present disclosure is not limited thereto. For example, a plurality of light emitting elements may be provided in each pixel. At this time, the plurality of light emitting elements may be connected in series, in parallel, in series-parallel, or the like.

The first power voltage ELVDD may be greater than the second power voltage ELVSS. However, in a special situation such as preventing the light emitting element LD from emitting light, the second power voltage ELVSS may be set greater than the first power voltage ELVDD.

The sensing channel 151 may include a first switch SW1, a second switch SW2, and a sensing capacitor Css.

A first electrode of the first switch SW1 may be connected to the third node N3. For example, the third node N3 may be connected to the sensing line Ik. A second electrode of the first switch SW1 may receive an initialization voltage Vint. For example, the second electrode of the first switch SW1 may be connected to initialization power supplying the initialization voltage Vint.

A first electrode of the second switch SW2 may be connected to the third node N3, and a second electrode of the second switch SW2 may be connected to the fourth node N4.

A first electrode of the sensing capacitor Css may be connected to the fourth node N4, and a second electrode of the sensing capacitor Css may be connected to reference power (for example, ground).

Although not shown, the sensing unit 15 may include an analog-to-digital converter. For example, the sensing unit 15 may include analog-to-digital converters. For example, the number of analog-digital converters in the sensing unit 15 may correspond to the number of sensing channels. The analog-to-digital converter may convert a sensing voltage stored in the sensing capacitor Css into a digital value. The converted digital value may be provided to the timing controller 11 as sensing data. In another example, the sensing unit 15 may include analog-to-digital converters whose number is less than the number of the sensing channels, and may convert sensing signals stored in the sensing channels in a time-division method.

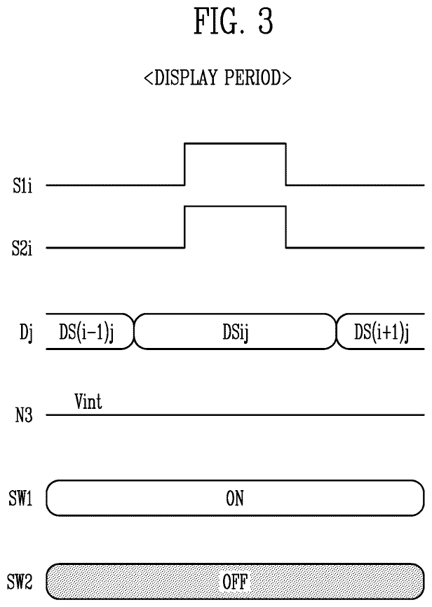

FIG. 3 is a waveform diagram during a display period according to an embodiment of the disclosure.

Referring to FIG. 3, during the display period, the sensing line Ik, that is, the third node N3, may receive the initialization voltage Vint. During the display period, the first switch SW1 may be turned on, and the second switch SW2 may be turned off.

During the display period, data voltages DS(i−1)j, DSij, and DS(i+1)j may be sequentially applied to the data line Dj in each horizontal period unit. A turn-on level (for example, a logic high level) of first scan signal may be applied to the first scan line S1i in a corresponding horizontal period. In addition, a turn-on level of second scan signal may also be applied to the second scan line S2i in synchronization with the first scan line S1i. However, the present disclosure is not limited thereto. For example, during the display period, the turn-on level of second scan signal may always be applied to the second scan line S2i.

The second transistor T2 and the third transistor T3 may be turned when the turn-on level of scan signals are applied to the first scan line S1i and the second scan line S2i. Therefore, a voltage corresponding to a difference between the data voltage DSij and the initialization voltage Vint is written to the storage capacitor Cst of the pixel SPij.

In the pixel SPij, in response to a voltage difference between the gate electrode and the source electrode of the first transistor T1, the amount of the driving current flowing through a driving path connecting the first power voltage ELVDD, the first transistor T1, the light emitting element LD, and the second power voltage ELVSS is determined. A luminance of the light emitting element LD may be determined based on the amount of the driving current.

When a turn-off level (for example, a logic low level) of scan signal is applied to the first scan line S1i and the second scan line S2i, the second transistor T2 and the third transistor T3 may be turned off. Therefore, regardless of voltage changes of the data line Dj, the voltage difference between the gate electrode and the source electrode of the first transistor T1 may be maintained by the storage capacitor Cst, and the luminance of the light emitting element LD may be maintained.

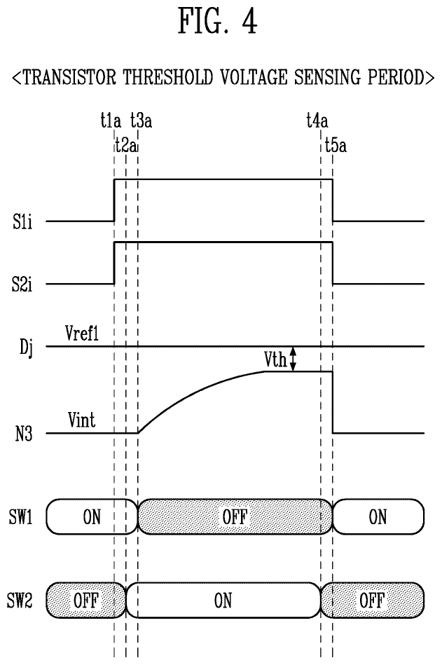

FIG. 4 is a waveform diagram during a threshold voltage sensing period of a transistor according to an embodiment of the disclosure.

Before a time point t1a, the first switch SW1 may be in a turn-on state, and the second switch SW2 may be in a turn-off state. Therefore, the initialization voltage Vint may be applied to the third node N3. In addition, the data driver 12 may supply a reference voltage Vref1 to the data line Dj. According to an embodiment, the reference voltage Vref1 may be set to be higher than the initialization voltage Vint.

At the time point t1a, the turn-on level of first scan signal may be supplied to the first scan line S1i, and the turn-on level of second scan signal may be supplied to the second scan line S2i. Accordingly, the reference voltage Vref1 may be applied to the first node N1, and the initialization voltage Vint may be applied to the second node N2. Accordingly, the first transistor T1 may be turned on in response to a difference between a gate voltage and a source voltage.

At a time point t2a, the second switch SW2 may be turned on. Accordingly, the first electrode of the sensing capacitor Css (for example, the fourth node N4) may be initialized to the initialization voltage Vint.

At a time point t3a, the first switch SW1 may be turned off. Accordingly, as a current is supplied from the first power voltage ELVDD, a voltage of the second node N2 and the third node N3 may increase. When the voltage of the second node N2 and the third node N3 increases and reaches a voltage (Vref1−Vth), the first transistor T1 is turned off, and thus the voltage of the second node N2 and the third node N3 does not increase further. Because the fourth node N4 is connected to the third node N3 through the turned on second switch SW2, a sensing voltage (Vref1−Vth) is stored in the first electrode of the sensing capacitor Css.

At a time point t4a, the second switch SW2 may be turned off, and thus the sensing voltage (Vref1−Vth) of the first electrode of the sensing capacitor Css may be maintained. The sensing unit 15 may perform analog-to-digital conversion of the sensing voltages (Vref1−Vth), and thus may determine a threshold voltage Vth of the first transistor T1 of the pixel SPij.

At a time point t5a, the turn-off level of first scan signal may be supplied to the first scan line S1i, and a turn-off level of second scan signal may be supplied to the second scan line S2i. In addition, the first switch SW1 may be turned on. Accordingly, the initialization voltage Vint may be applied to the third node N3.

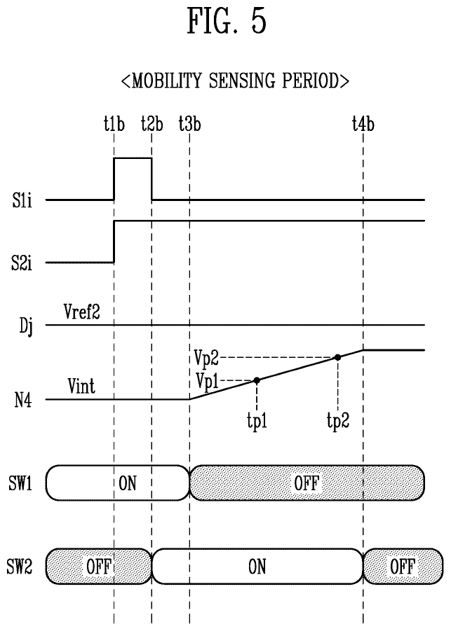

FIG. 5 is a waveform diagram during a mobility sensing period according to an embodiment of the disclosure.

At a time point t1b, the turn-on level of first scan signal may be applied to the first scan line S1i and the turn-on level of second scan signal may be applied to the second scan line S2i. At this time, because a reference voltage Vref2 is applied to the data line Dj, the reference voltage Vref2 may be applied to the first node N1. In addition, because the first switch SW1 is in a turn-on state, the initialization voltage Vint may be applied to the second node N2 and the third node N3. Accordingly, the first transistor T1 may be turned on according to the difference between a gate voltage and a source voltage. Because the reference voltage Vref2 may have a higher voltage than the initialization voltage Vint.

At a time point t2b, as the turn-off level of first scan signal is applied to the first scan line S1i, the first node N1 may be in a floating state. In addition, the initialization voltage Vint may be applied to the fourth node N4 as the second switch SW2 is turned on.

At a time point t3b, the first switch SW1 may be turned off. Accordingly, as a current is supplied from the first power voltage ELVDD through the first transistor T1, a voltage of the second, third, and fourth nodes N2, N3, and N4 increases. At this time, because the first node N1 is in the floating state, a gate-source voltage difference of the first transistor T1 may be maintained.

At a time point t4b, the second switch SW2 may be turned off. Accordingly, the sensing voltage is stored in the first electrode of the sensing capacitor Css. A sensing current of the first transistor T1 may be obtained as in Equation 1 below.

$$I = {C}^{*} ( Vp 2 - Vp 1 ) / ( tp 2 - tp 1 ) \qquad [ Equation 1 ]$$

Here, I is the sensing current of the first transistor T1, C is a capacitance of the sensing capacitor Css, Vp2 is the sensing voltage at the time point tp2, and Vp1 is the sensing voltage at the time point tp1.

Assuming that a voltage slope of the fourth node N4 between the time point t3b and the time point t4b is linear, as we know the sensing voltage at the time point t3b and the sensing voltage at the time point t4b, we may calculate the sensing current of the first transistor T1. In addition, mobility of the first transistor T1 may be calculated using the calculated sensing current. For example, as the sensing current increases, the mobility may increase. For example, a magnitude of the mobility may be proportional to a magnitude of the sensing current.

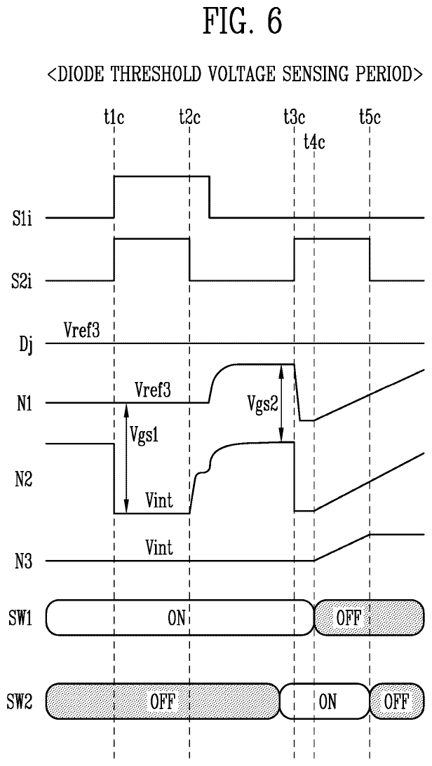

FIG. 6 is a waveform diagram during a threshold voltage sensing period of a light emitting diode according to an embodiment of the disclosure.

At a time point t1c, the turn-on level of first scan signal may be applied to the first scan line S1i and the turn-on level of second scan signal may be applied to the second scan line S2i. At this time, because a reference voltage Vref3 is applied to the data line Dj, the reference voltage Vref3 may be applied to the first node N1. Because the first switch SW1 is in a turn-on state, the initialization voltage Vint may be applied to the second node N2 and the third node N3. Therefore, the first transistor T1 may be turned on according to a gate-source voltage Vgs1. Because the reference voltage Vref3 may have a higher voltage than the initialization voltage Vint.

At a time point t2c, the turn-off level of second scan signal may be applied to the second scan line S2i. In addition, at the time point t2c or immediately after the time point t2c, the turn-off level of first scan signal may be applied to the first scan line S1i. At this time, the voltage of the second node N2 increases by the current supplied from the first power voltage ELVDD. In addition, as the first node N1 is coupled to the second node N2 and in a floating state, the voltage of the first node N1 also increases. At this time, the voltage of the second node N2 is saturated to a voltage corresponding to a threshold voltage of the light emitting element LD. As a deterioration degree of the light emitting element LD increases, the saturated voltage of the second node N2 may increase. A gate-source voltage Vgs2 of the first transistor T1 may be reset by the saturated voltage of the second node N2. For example, the reset gate-source voltage Vgs2 may be less than the preset gate-source voltage Vgs1.

At a time point t3c, the turn-on level of second scan signal may be applied to the second scan line S2i. Accordingly, the initialization voltage Vint may be applied to the second node N2. At this time, the reset gate-source voltage Vgs2 may be maintained by the storage capacitor Cst.

At a time point t4c, the first switch SW1 may be turned off. At this time, because the second switch SW2 is in a turn-on state, the voltage of the second node N2, the third node N3, and the fourth node N4 may increase. As the deterioration degree of the light emitting element LD (or the threshold voltage of the light emitting element LD) increases, a voltage increase slope may decrease.

At a time point t5c, the turn-off level of second scan signal may be applied to the second scan line S2i, and the second switch SW2 may be turned off. Accordingly, the threshold voltage of the light emitting element LD may be calculated using the sensing voltage stored in the sensing capacitor Css.

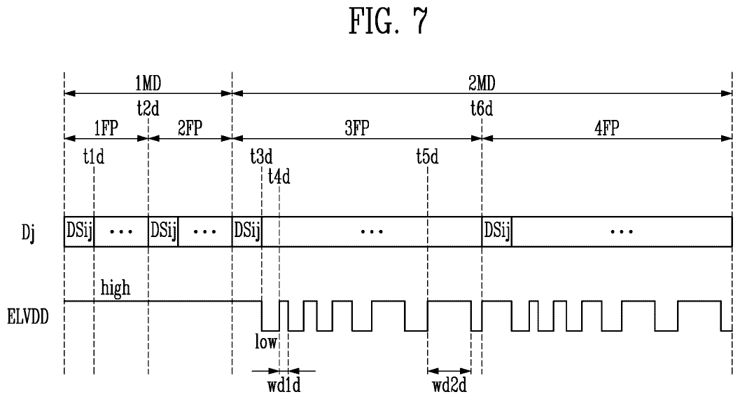

FIG. 7 is a timing diagram illustrating a first mode and a second mode according to an embodiment of the disclosure.

Referring to FIG. 7, the display device DD may be driven in the first mode or the second mode during the display period.

FIG. 7 shows a timing when the display device DD displays two image frames in the first mode 1MD and displays another two image frames in the second mode 2MD.

The first mode 1MD may be a mode that displays image frames at a relatively high frequency. The second mode 2MD may be a mode that displays image frames at a relatively low frequency. For example, the display device DD may reduce power consumption by displaying an image in the second mode 2MD when a user input is not received during a certain time. Each of frame periods 1FP and 2FP in the first mode 1MD may be shorter than each of frame periods 3FP and 4FP in the second mode.

The power supply 16 may provide the first power voltage ELVDD to maintain a constant voltage level during a first period t1d to t2d in the first mode 1MD. The time point t1d represents when the second transistor T2 is turned off, and a time point t2d represents when the second transistor T2 is turned on again in the first mode 1MD. For example, the first power voltage ELVDD may be maintained at a first voltage level (for example, a high level) during the first period t1d to t2d.

In the second mode 2MD, the power supply 16 may provide the first power voltage ELVDD in a pulse width modulation method in which a duty ratio gradually increases during a second period t3d to t6d. The time point t3d represents when the second transistor T2 is turned off, and the time point t6d represents when the second transistor T2 is turned on again in the second mode 2MD. The second period t3d to t6d may be a modulation period of the first power voltage ELVDD. The second period t3d to t6d may be longer than the first period t1d to t2d.

The first power voltage ELVDD may include a first voltage level (for example, a high level) that turns on the light emitting element LD and a second voltage level (for example, a low level) that turns off the light emitting element LD. According to an embodiment, the second voltage level of the first power voltage ELVDD may be greater than a voltage level of the second power voltage ELVSS. However, the present disclosure is not limited thereto. For example, the second voltage level of the first power voltage ELVDD may be less than or equal to the voltage level of the second power voltage ELVSS. During the second period t3d to t6d, as the duty ratio increases, a period when the first power voltage ELVDD has the first voltage level may increase and a period when the first power voltage ELVDD has the second voltage level may decrease. That is, the period when the first power voltage ELVDD has the first voltage level near the time point t3d is shorter than the period when the first power voltage ELVDD has the first voltage level near the time point t6d.

During the second period t3d to t6d, as the duty ratio increases, a width of each pulses maintained at the first voltage level may increase. For example, a width wd2d of a pulse of the first power voltage ELVDD generated at a time point t5d may be greater than a width wd1d of the pulse of the first power voltage ELVDD generated at a time point t4d.

According to an embodiment, by gradually increasing a light emission time during the second period t3d to t6d (for example, by increasing the width of the first power voltage ELVDD having the first voltage level during the second period), it is possible to compensate for a gradual luminance decrease caused by a leakage current generated at the second node N2 of the pixel SPij. In addition, the intermittently applied first power voltage ELVDD having the second voltage level during the second period t3d to t6d may lead to eliminating an afterimage that may occur in low-frequency driving. Therefore, according to an embodiment, the display device DD may minimize abnormal display even when driven at a low frequency.

While the second transistor T2 receives the data voltage DSij, the voltage level of the first power voltage ELVDD may be maintained. For example, the first power voltage ELVDD may be maintained at the first voltage level (for example, high level) while the second transistor T2 is turned on and receives the data voltage DSij. According to an embodiment, a case where an incorrect data voltage DSij is written to the storage capacitor Cst may be prevented.

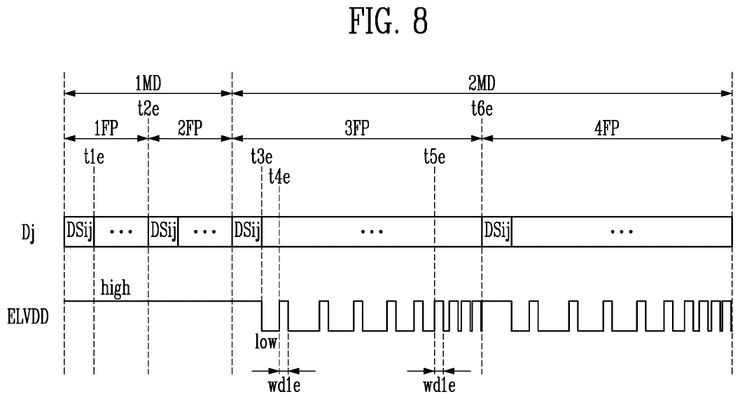

FIG. 8 is a timing drawing illustrating a first mode and a second mode according to an embodiment of the disclosure.

Referring to FIG. 8, the display device DD may be driven in the first mode or the second mode during the display period.

FIG. 8 shows a timing when the display device DD displays two image frames in the first mode 1MD and displays another two two image frames in the second mode 2MD. In describing FIG. 8, a description of a content overlapping that of FIG. 7 is omitted.

The power supply 16 may provide the first power voltage ELVDD to maintain a constant voltage level during a first period t1e to t2e in the first mode 1MD. The time point t1e represents when the second transistor T2 is turned off, and the time point t2e represents when the second transistor T2 is turned on again in the first mode 1MD. For example, the first power voltage ELVDD may be maintained at the first voltage level (for example, high level) during the first period t1e to t2e.

In the second mode 2MD, the power supply 16 may provide the first power voltage ELVDD in a pulse width modulation method in which a duty ratio gradually increases during a second period t3d to t6d. The time point t3e represents when the second transistor T2 is turned off, and the time point the represents when the second transistor T2 is turned on again in the second mode 2MD. The second period t3e to t6e may be a modulation period of the first power voltage ELVDD. The second period t3e to the may be longer than the first period t1e to t2e.

The first power voltage ELVDD may include the first voltage level (for example, high level) that turns on the light emitting element LD and the second voltage level (for example, low level) that turns off the light emitting element LD. During the second period t3e to t6e, as the duty ratio increases, the period when the first power voltage ELVDD has the first voltage level may increase and the period when the first power voltage ELVDD has the second voltage level may decrease.

During the second period t3e to t6e, as the duty ratio increases, the width of the pulses maintained at the first voltage level may be the same as each other during the second period t3e to t6e, and a time interval between the pulses may be decreased. For example, a width wd1e of the pulse of the first power voltage ELVDD generated at a time point t5e may be the same as a width wd1e of the pulse of the first power voltage ELVDD generated at a time point t4e. However, an interval between the pulse generated at the time point t5e and a next pulse may be narrower than an interval between the pulse generated at the time point t4e and a next pulse.

According to an embodiment, by gradually increasing the light emission time during the second period t3e to t6e (for example, by decreasing the interval between adjacent pulses), it is possible to compensate for a gradual luminance decrease caused by a leakage current generated at the second node N2 of the pixel SPij. In addition, the intermittently applied first power voltage ELVDD having the second voltage level during the second period t3d to t6d may lead to eliminating an afterimage that may occur in low-frequency driving. Therefore, according to an embodiment, the display device DD may minimize abnormal display even when driven at a low frequency.

The voltage level of the first power voltage ELVDD may be maintained while the second transistor T2 receives the data voltage DSij. For example, the first power voltage ELVDD may be maintained at the first voltage level (for example, high level) while the second transistor T2 is turned on and receives the data voltage DSij. According to an embodiment, a case where an incorrect data voltage DSij is written to the storage capacitor Cst may be prevented.

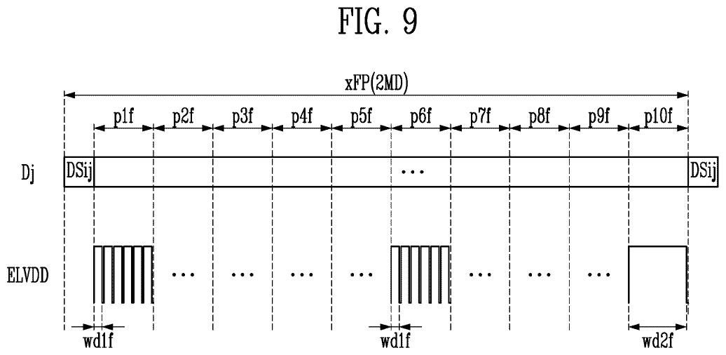

FIGS. 9 to 11 are drawings illustrating a second mode according to an embodiment of the disclosure. In describing FIGS. 9 to 11, a description of a content overlapping those of FIGS. 7 and 8 is omitted.

Referring to FIG. 9, an arbitrary frame period xFP of the second mode 2MD is shown. A second period of one frame period xFP, that is, a modulation period of the first power voltage ELVDD, may include a plurality of sub-periods p1f, p2f, p3f, p4f, p5f, p6f, p7f, p8f, p9f, and p10f. In FIG. 9, the number of sub-periods p1f to p10f is shown as ten, but the number of sub-periods p1f to p10f is not limited thereto.

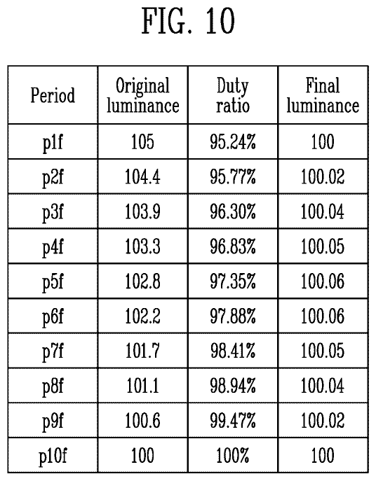

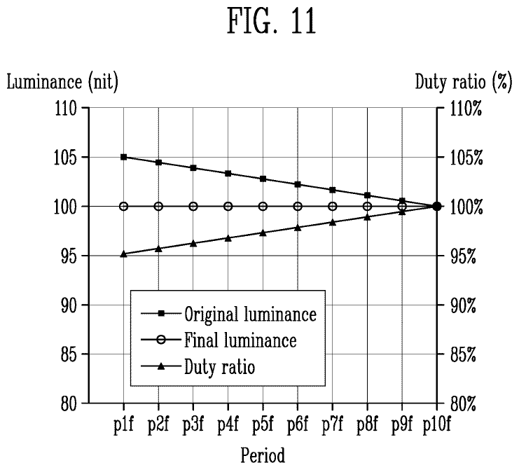

Referring to FIGS. 10 and 11, different duty ratios may be set with respect to the sub-periods p1f to p10f. The duty ratios may be set to ensure that a final luminance remains substantially the same across all sub-periods p1f to p10f, reflecting the decrease in an original luminance over time due to a leakage current. Therefore, the duty ratios may be set to gradually increase with respect to the sub-periods p1f to p10f. A value obtained by multiplying the original luminance and the duty ratio may be calculated as the final luminance. However, as shown in the table in FIG. 10, the duty ratio may be further finely adjusted based on a specification of the display device DD.

According to an embodiment, the timing controller 11 in setting the data voltage DSij may set the output grayscale to be higher than the input grayscale in consideration of the final luminance. For example, as shown in FIGS. 10 and 11, if approximately 5% luminance loss is expected, the data voltage DSij may be set to have a luminance of the output grayscale to be higher than a luminance of the input grayscale by 5%. For example, the data voltage DSij may be set to have the output grayscale to correspond to a luminance of 105 nits when the input grayscale corresponds to a luminance of 100 nits. The final luminance during the sub-period p1f may be 100 nits by applying the data voltage DSij having a luminance of the output grayscale to be 105 nits and by setting the duty ratio to about 95.24% during the sub-period p1f.

Referring to FIG. 9 again, the first power voltage ELVDD may include first pulses having a first width wd1f of the first voltage level and a second pulse having a second width wd2f of the first voltage level. At this time, the second width wd2f may be greater than the first width wd1f.

During the modulation period, as the duty ratio increases, a time interval between the first pulses may be decreased. For example, a time interval between the first pulses during the sub-period p6f may be narrower than a time interval between the first pulses during the sub-period p1f. In addition, a last pulse (that is, a pulse of the sub-period 10f) of the modulation period may be a second pulse. For example, because the duty ratio is set to 100% in the last sub-period 10f, a period in which the first power voltage ELVDD has the second voltage level may not exist during the sub-period 10f.

According to an embodiment, by gradually increasing the light emission time during the modulation period, it is possible to compensate for the gradual luminance decrease caused by the leakage current generated at the second node N2 of the pixel SPij. In addition, the intermittently applied first power voltage ELVDD having the second voltage level during the second period t3d to t6d may lead to eliminating an afterimage that may occur in low-frequency driving. Therefore, according to an embodiment, the display device DD may minimize abnormal display even when driven at a low frequency.

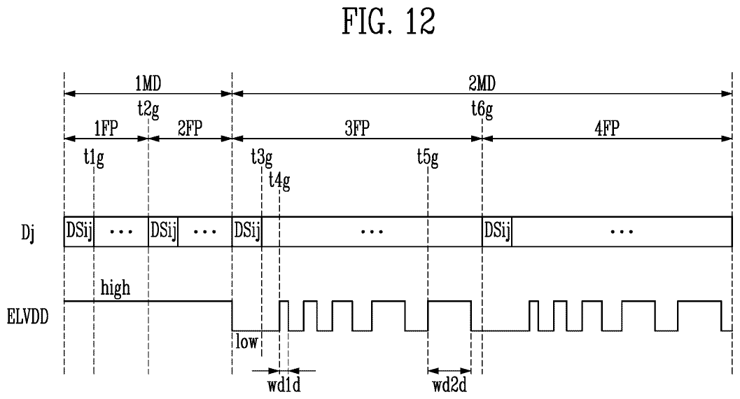

FIG. 12 is a timing diagram illustrating a first mode and a second mode according to an embodiment of the disclosure.

A driving method at each of time points t1g, t2g, t3g, t4g, t5g, and t6g of FIG. 12 is substantially the same as a driving method at each of the time points t1d, t2d, t3d, t4d, t5d, and t6d of FIG. 7, and thus an overlapping content is not described.

The voltage level of the first power voltage ELVDD may be maintained while the second transistor T2 receives the data voltage DSij. For example, in the first mode 1MD, the first power voltage ELVDD may be maintained at the first voltage level (for example, high level) while the second transistor T2 receives the data voltage DSij. For example, in the second mode 2MD, the first power voltage ELVDD may be maintained at the second voltage level (for example, low level) while the second transistor T2 receives the data voltage DSij. According to an embodiment, a case where an incorrect data voltage DSij is written to the storage capacitor Cst may be prevented.

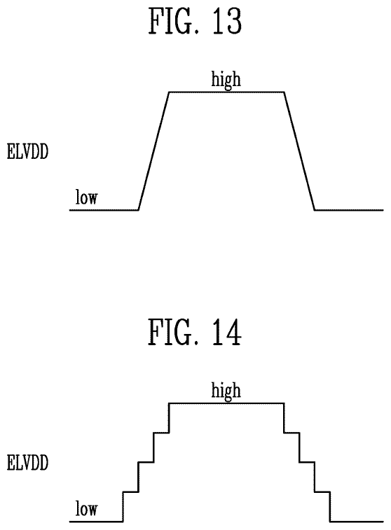

FIGS. 13 and 14 are diagrams illustrating a case where a slew rate is applied to a voltage level change of the first power voltage.

Referring to FIG. 13, during the modulation period, the voltage level of the first power voltage ELVDD may be linearly changed. Referring to FIG. 14, during the modulation period, the voltage level of the first power voltage ELVDD may be changed in a stepped manner.

According to an embodiment, power ripple, noise, or the like caused by a sudden voltage level change of the first power voltage ELVDD may be prevented.

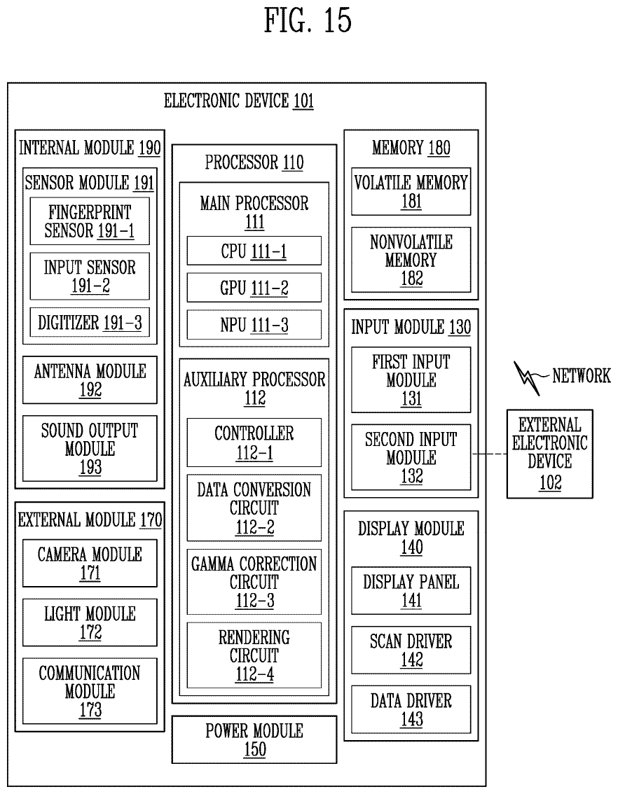

FIG. 15 is a block diagram of an electronic device according to embodiments of the disclosure.

The electronic device 101 outputs various information through a display module 140 in an operating system. The display module 140 provides application information to a user through a display panel 141 when a processor 110 executes an application stored in a memory 180.

The processor 110 obtains an external input through an input module 130 or a sensor module 191 and executes an application corresponding to the external input. For example, the processor 110 obtains a user input through an input sensor 191-2 and activates a camera module 171 when the user selects a camera icon displayed on the display panel 141. The processor 110 transmits image data corresponding to a captured image obtained through the camera module 171 to the display module 140. The display module 140 may display an image corresponding to the captured image through the display panel 141.

As another example, a fingerprint sensor 191-1 obtains a user's fingerprint information as an input data when a personal information authentication is executed in the display module 140. The processor 110 compares the input data obtained through the fingerprint sensor 191-1 with authentication data stored in the memory 180 and executes an application according to a comparison result. The display module 140 may display information executed according to a logic of the application through the display panel 141.

As another example, the processor 110 obtains a user input through the input sensor 191-2 and activates a music streaming application stored in the memory 180 when a music streaming icon displayed on the display module 140 is selected. The processor 110 activates a sound output module 193 to provide sound information corresponding to the music execution command to the user when a music execution command is input in the music streaming application.

In the above, an operation of the electronic device 101 is briefly described. Hereinafter, components of the electronic device 101 are described in detail. Some of the components of the electronic device 101 to be described later may be integrated and provided as a single component, and the single component may be separated into two or more components and provided.

Referring to FIG. 15, the electronic device 101 may communicate with an external electronic device 102 through a network (for example, a short-range wireless communication network or a long-range wireless communication network). According to an embodiment, the electronic device 101 may include the processor 110, the memory 180, the input module 130, the display module 140, a power module 150, an internal module 190, and an external module 170. According to an embodiment, in the electronic device 101, at least one of the above-described components may be omitted or one or more other components may be added. According to an embodiment, some of the above-described components (for example, the sensor module 191, an antenna module 192, or the sound output module 193) may be integrated into another component (for example, the display module 140).

The processor 110 may execute software to control at least another component (for example, a hardware or software component) of the electronic device 101 connected to the processor 110, and perform various data processing or operations. According to an embodiment, as part of data processing or computation, the processor 110 may store a command or data received from another component (for example, the input module 130, the sensor module 191, or a communication module 173) in a volatile memory 181. The processor 110 may process the command or the data stored in the volatile memory 181, and the resulting data may be stored in a nonvolatile memory 182.

The processor 110 may include a main processor 111 and an auxiliary processor 112. The main processor 111 may include one or more of a central processing unit (CPU) 111-1 or an application processor (AP). The main processor 111 may further include any one or more of a graphic processing unit (GPU) 111-2, a communication processor (CP), and an image signal processor (ISP). The main processor 111 may further include a neural processing unit (NPU) 111-3. The NPU is a processor specialized in processing an artificial intelligence model, and the artificial intelligence model may be generated through machine learning. The artificial intelligence model may include a plurality of artificial neural network layers. The artificial neural network may be one of a deep neural network (DNN), a convolutional neural network (CNN), a recurrent neural network (RNN), a restricted boltzmann machine (RBM), a deep belief network (DBN), a bidirectional recurrent deep neural network (BRDNN), a deep Q-network, or a combination of two or more of the above, but is not limited to the above-described example. The artificial intelligence model may include a software structure in addition to a hardware structure. At least two of the above-described processing units and processors may be implemented as one integrated configuration (for example, a single chip), or each may be implemented as an independent configuration (for example, a plurality of chips).

The auxiliary processor 112 may include a controller 112-1. The controller 112-1 may include an interface conversion circuit and a timing control circuit. The controller 112-1 receives an image signal (e.g. an image frame including grayscales) from the main processor 111, converts a data format of the image signal to correspond to an interface specification of the display module 140, and outputs image data. The controller 112-1 may output various control signals necessary for driving the display module 140.

The auxiliary processor 112 may further include a data conversion circuit 112-2, a gamma correction circuit 112-3, a rendering circuit 112-4, or the like. The data conversion circuit 112-2 may receive the image data from the controller 112-1, compensate the image data to display an image with a desired luminance according to a characteristic of the electronic device 101, a setting of the user, or the like, or convert the image data for reduction of power consumption, afterimage compensation, or the like. The gamma correction circuit 112-3 may convert the image data, a gamma reference voltage, or the like so that the image displayed on the electronic device 101 has a desired gamma characteristic. The rendering circuit 112-4 may receive the image data from the controller 112-1 and render the image data in consideration of a pixel disposition or the like of the display panel 141 applied to the electronic device 101. At least one of the data conversion circuit 112-2, the gamma correction circuit 112-3, and the rendering circuit 112-4 may be integrated into another component (for example, the main processor 111 or the controller 112-1). At least one of the data conversion circuit 112-2, the gamma correction circuit 112-3, or the rendering circuit 112-4 may be integrated into a data driver 143 to be described later.

The memory 180 may store various data used by at least one component (for example, the processor 110 or the sensor module 191) of the electronic device 101, and input data or output data for a command related thereto. The memory 180 may include at least one of the volatile memory 181 or the nonvolatile memory 182.

The input module 130 may receive a command or data to be used by a component (for example, the processor 110, the sensor module 191, or the sound output module 193) of the electronic device 101 from an outside (for example, the user or the external electronic device 102) of the electronic device 101.

The input module 130 may include a first input module 131 to which a command or data is input from the user and a second input module 132 to which a command or data is input from the external electronic device 102. The first input module 131 may include a microphone, a mouse, a keyboard, a key (for example, a button), or a pen (for example, a passive pen or an active pen). The second input module 132 may support a designated protocol capable of connecting to the external electronic device 102 by wire or wirelessly. According to an embodiment, the second input module 132 may include a high definition multimedia interface (HDMI), a universal serial bus (USB) interface, an SD card interface, or an audio interface. The second input module 132 may include a connector capable of physically connecting to the external electronic device 102, for example, an HDMI connector, a USB connector, an SD card connector, or an audio connector (for example, a headphone connector).

The display module 140 visually provides information to the user. The display module 140 may include the display panel 141, a scan driver 142, and the data driver 143. The display module 140 may further include a window, a chassis, and a bracket for protecting the display panel 141.

The display panel 141 may include a liquid crystal display panel, an organic light emitting display panel, or an inorganic light emitting display panel, and a type of the display panel 141 is not particularly limited. The display panel 141 may be a rigid type or a flexible type that may be rolled or folded. The display module 140 may further include a supporter, a bracket, a heat dissipation member, or the like that supports the display panel 141.

The scan driver 142 may be mounted on the display panel 141 as a driving chip. In addition, the scan driver 142 may be integrated on the display panel 141. For example, the scan driver 142 may include an amorphous silicon TFT gate driver circuit (ASG), a low temperature polycrystalline silicon (LTPS) TFT gate driver circuit, or an oxide semiconductor TFT gate driver circuit (OSG) built in the display panel 141. The scan driver 142 receives a control signal from the controller 112-1 and outputs the scan signals to the display panel 141 in response to the control signal.

The display panel 141 may further include an emission driver. The emission driver outputs an emission control signal to the display panel 141 in response to the control signal received from the controller 112-1. The emission driver may be formed separately from the scan driver 142 or integrated into the scan driver 142.

The data driver 143 receives the control signal from the controller 112-1, converts image data into an analog voltage (for example, a data voltage) in response to the control signal, and then outputs the data voltages to the display panel 141.

The data driver 143 may be integrated into another component (for example, the controller 112-1). A function of the interface conversion circuit and the timing control circuit of the controller 112-1 described above may be integrated into the data driver 143.

The display module 140 may further include the emission driver, a voltage generation circuit, or the like. The voltage generation circuit may output various voltages necessary for driving the display panel 141.

The power module 150 supplies power to a component of the electronic device 101. The power module 150 may include a battery. The battery may include a non-rechargeable primary cell, and a rechargeable secondary cell or fuel cell. The power module 150 may include a power management integrated circuit (PMIC). The PMIC supplies optimized power to each of the above-described module and a module to be described later. The power module 150 may include a wireless power transmission and reception member electrically connected to the battery. The wireless power transmission and reception member may include a plurality of antenna radiators in the form of coil.

The electronic device 101 may further include the internal module 190 and the external module 170. The internal module 190 may include the sensor module 191, the antenna module 192, and the sound output module 193. The external module 170 may include the camera module 171, a light module 172, and the communication module 173.

The sensor module 191 may sense an input by a body of the user or an input by a pen among the first input module 131, and may generate an electrical signal or a data value corresponding to the input. The sensor module 191 may include at least one of the fingerprint sensor 191-1, the input sensor 191-2, or a digitizer 191-3.

The fingerprint sensor 191-1 may generate a data value corresponding to a fingerprint of the user. The fingerprint sensor 191-1 may include any one of an optical type fingerprint sensor or a capacitive type fingerprint sensor.

The input sensor 191-2 may generate a data value corresponding to coordinate information of the input by the body of the user or the pen. The input sensor 191-2 generates a data value based on the capacitance change caused by the input. The input sensor 191-2 may sense an input by the passive pen or may transmit and receive data to and from the active pen.

The input sensor 191-2 may measure a biometric signal such as blood pressure, water, or body fat. For example, the input sensor 191-2 may sense the biometric signal based on a change of an electric field by the body part and output information desired by the user to the display module 140 when the user touches a sensor layer or a sensing panel with a body part and remains still for a certain period.

The digitizer 191-3 may generate a data value corresponding to the coordinate information of input made by a pen. The digitizer 191-3 generates a data value based on an electromagnetic change made by an input. The digitizer 191-3 may sense an input by a passive pen or transmit or receive data to or from the active pen.

At least one of the fingerprint sensor 191-1, the input sensor 191-2, or the digitizer 191-3 may be implemented as a sensor layer formed on the display panel 141 through a successive process. The fingerprint sensor 191-1, the input sensor 191-2, and the digitizer 191-3 may be located on the display panel 141, and any one of the fingerprint sensor 191-1, the input sensor 191-3, or the digitizer 191-3, for example, the digitizer 191-3 may be located under the display panel 141.

At least two of the fingerprint sensor 191-1, the input sensor 191-2, or the digitizer 191-3 may be formed to be integrated into one sensing panel through a same process. The sensing panel may be located between the display panel 141 and a window located above the display panel 141. According to an embodiment, the sensing panel may be located on the window, and a position of the sensing panel is not particularly limited.

At least one of the fingerprint sensor 191-1, the input sensor 191-2, or the digitizer 191-3 may be embedded in the display panel 141. That is, at least one of the fingerprint sensor 191-1, the input sensor 191-2, or the digitizer 191-3 may be simultaneously formed through a process of forming elements (for example, a light emitting element, a transistor, and the like) included in the display panel 141.

In addition, the sensor module 191 may generate an electrical signal or a data value corresponding to an internal state or an external state of the electronic device 101. The sensor module 191 may further include, for example, a gesture sensor, a gyro sensor, a barometric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The antenna module 192 may include one or more antennas for transmitting a signal or power to an outside or receiving a signal or power from an outside. According to an embodiment, the communication module 173 may transmit a signal to an external electronic device or receive a signal from an external electronic device through an antenna suitable for a communication method. An antenna pattern of the antenna module 192 may be integrated into one configuration (for example, the display panel 141) of the display module 140 or the input sensor 191-2.

The sound output module 193 is a device for outputting a sound signal to an outside of the electronic device 101, and may include, for example, a speaker used for general purposes such as multimedia playback or recording playback, and a receiver used exclusively for receiving a call. According to an embodiment, the receiver may be formed integrally with or separately from the speaker. A sound output pattern of the sound output module 193 may be integrated into the display module 140.

The camera module 171 may capture a still image and a moving image. According to an embodiment, the camera module 171 may include one or more lenses, an image sensor, or an image signal processor. The camera module 171 may further include an infrared camera capable of measuring presence or absence of the user, a position of the user, a gaze of the user, and the like.

The light module 172 may provide light. The light module 172 may include a light emitting diode or a xenon lamp. The light module 172 may operate in conjunction with the camera module 171 or may operate independently.

The communication module 173 may support the establishment of a wired or wireless communication channel between the electronic device 101 and the external electronic device 102 and communication performance through the established communication channel. The communication module 173 may include any one or both of a wireless communication module such as a cellular communication module, a short-range wireless communication module, or a global navigation satellite system (GNSS) communication module, and a wired communication module such as a local area network (LAN) communication module or a power line communication module. The communication module 173 may communicate with the external electronic device 102 through a short-range communication network such as Bluetooth, WiFi direct, or infrared data association (IrDA), or a long-range communication network such as a cellular network, the Internet, or a computer network (for example, LAN or WAN). The above-described various types of communication modules 1173 may be implemented as a single chip or as separate chips.

The input module 130, the sensor module 191, the camera module 171, and the like may be used to control an operation of the display module 140 in conjunction with the processor 110.

The processor 110 outputs a command or data to the display module 140, the sound output module 193, the camera module 171, or the light module 172 based on input data received from the input module 130. For example, the processor 110 may generate image data in response to the input data applied through a mouse, an active pen, or the like and output the image data to the display module 140, or generate command data in response to the input data and output the command data to the camera module 171 or the light module 172. The processor 110 may convert an operation mode of the electronic device 101 to a low power mode or a sleep mode to reduce power consumed in the electronic device 101 when the input data is not received from the input module 130 during a certain period of time.

The processor 110 outputs a command or data to the display module 140, the sound output module 193, the camera module 171, or the light module 172 based on sensing data received from the sensor module 191. For example, the processor 110 may compare authentication data applied by the fingerprint sensor 191-1 with authentication data stored in the memory 180 and then execute an application according to a comparison result. The processor 110 may execute the command based on sensing data sensed by the input sensor 191-2 or the digitizer 191-3, or output corresponding image data to the display module 140. The processor 110 may receive temperature data for a measured temperature from the sensor module 191 and further perform luminance correction or the like on the image data based on the temperature data when the sensor module 191 includes a temperature sensor.

The processor 110 may receive measurement data for the presence of the user, the position of the user, the gaze of the user, and the like, from the camera module 171. The processor 110 may further perform luminance correction or the like on the image data based on the measurement data. For example, the processor 110 determining the presence or absence of the user through an input from the camera module 171 may output image data of which a luminance is corrected through the data conversion circuit 112-2 or the gamma correction circuit 112-3 to the display module 140.

Some of the above-described components may be connected to each other through a communication method between peripheral devices, for example, a bus, general purpose input/output (GPIO), a serial peripheral interface (SPI), a mobile industry processor interface (MIPI), or an ultra path interconnect (UPI) link to exchange a signal (for example, a command or data) with each other. The processor 110 may communicate with the display module 140 through a mutually agreed interface, for example, may use any one of the above-described communication methods, and is not limited to the above-described communication method.

The electronic device 101 may include various types of devices. The electronic device 101 may include, for example, at least one of a portable communication device (for example, a smart phone), a computer device, a portable multimedia device, a portable medical device, a camera, a wearable device, or a home appliance. However, the electronic device 101 according to an embodiment is not limited to the above-described devices.

The drawings referred to so far and the detailed description of the disclosure described herein are merely examples of the disclosure, are used for merely describing the disclosure, and are not intended to limit the meaning and the scope of the disclosure described in claims. Therefore, those skilled in the art will understand that various modifications and changes can be made without departing from the spirit and scope of the present disclosure as set forth in the following claims.

What is claimed is:

1. A pixel comprising:
a first transistor having a first electrode receiving a first power voltage and controlling an amount of a driving current;
a second transistor having a first electrode connected to a data line and receiving a data voltage from the data line when the second transistor is turned on; and
a light emitting element emitting light with a luminance in response to the amount of the driving current,
wherein the first power voltage is provided in a pulse width modulation method in which a duty ratio of each of a plurality of pulses gradually increases during a modulation period from a first time point when the second transistor is turned off to a second time point when the second transistor is turned on again.

2. The pixel according to claim 1, wherein the first power voltage includes a first voltage level that turns on the light emitting element and a second voltage level that turns off the light emitting element, and
wherein, during the modulation period, a first period when the first power voltage has the first voltage level near the first time point is shorter than a second period when the first power voltage has the first voltage level near the second time point.

3. The pixel according to claim 2, wherein, during the modulation period, a first width of a pulse having the first voltage level near the first time point is shorter than a second width of a pulse having the first voltage level near the second time point.

4. The pixel according to claim 2, wherein, during the modulation period, a width of each of the plurality of pulses having the first voltage level is the same as each other, and a time interval between two pulses near the first time point is longer than a time interval between two pulses near the second time point.

5. The pixel according to claim 2, wherein the first power voltage includes first pulses each having a first width as the first voltage level and a second pulse having a second width as the first voltage level,
the second width is greater than the first width,
during the modulation period, as the duty ratio increases, time intervals between the first pulses are decreased, and
a last pulse of the modulation period is the second pulse.

6. The pixel according to claim 2, wherein while the second transistor receives the data voltage, a voltage level of the first power voltage is maintained.

7. The pixel according to claim 6, wherein while the second transistor receives the data voltage, the first power voltage has the first voltage level.

8. The pixel according to claim 6, wherein while the second transistor receives the data voltage, the first power voltage has the second voltage level.

9. The pixel according to claim 2, wherein, during the modulation period, a voltage level of the first power voltage is linearly changed.

10. The pixel according to claim 2, wherein during the modulation period, a voltage level of the first power voltage is changed in a stepped manner.

11. A display device comprising:
a plurality of pixels; and
a power supply configured to provide a first power voltage to the pixels,
wherein each of the pixels comprises:
a first transistor having a first electrode receiving the first power voltage and controlling an amount of a driving current;
a second transistor having a first electrode connected to a data line and receiving a data voltage from the data line when the second transistor is turned on; and
a light emitting element configured to emit light with a luminance in response to the amount of the driving current,
wherein the power supply provides the first power voltage in a constant voltage level during a first period from a time point when the second transistor is turned off to a time point when the second transistor is turned on again, in a first mode,
wherein the power supply provides the first power voltage in a pulse width modulation method in which a duty ratio of each of a plurality of pulses gradually increases during a second period from a first time point when the second transistor is turned off to a second time point when the second transistor is turned on again, in a second mode, and
wherein the second period is longer than the first period.

12. The display device according to claim 11, wherein the first power voltage includes a first voltage level that turns on the light emitting element and a second voltage level that turns off the light emitting element, and
wherein, during the second period, a third period when the first power voltage has the first voltage level near the first time point is shorter than a fourth period when the first power voltage has the first voltage level near the second time point.

13. The display device according to claim 12, wherein during the second period, a first width of a pulse having the first voltage level near the first time point is shorter than a second width of a pulse having the first voltage level near the second time point.

14. The display device according to claim 12, wherein during the second period, a width of each of the plurality of pulses having the first voltage level is the same as each other, and a time interval between two pulses near the first time point is longer than a time interval between two pulses near the second time point.

15. The display device according to claim 12, wherein the first power voltage includes first pulses each having a first width as the first voltage level and a second pulse having a second width as the first voltage level,
the second width is greater than the first width,
during the second period, as the duty ratio increases, time intervals between the first pulses are decreased, and
a last pulse of the second period is the second pulse.

16. The display device according to claim 12, wherein while the second transistor receives the data voltage, a voltage level of the first power voltage is maintained.

17. The display device according to claim 16, wherein while the second transistor receives the data voltage, the first power voltage has the first voltage level.

18. The display device according to claim 16, wherein while the second transistor receives the data voltage, the first power voltage has the second voltage level.

19. The display device according to claim 12, wherein, during the second period, a voltage level of the first power voltage is linearly changed.

20. An electronic device comprising:
a processor to provide an image signal; and
a display device to display an image based on the image signal,
wherein the display device comprises:
a plurality of pixels; and
a power supply configured to provide a first power voltage to the pixels,
wherein each of the pixels comprises:
a first transistor having a first electrode receiving the first power voltage and controlling an amount of a driving current;
a second transistor having a first electrode connected to a data line and receiving a data voltage from the data line when the second transistor is turned on; and
a light emitting element configured to emit light with a luminance in response to the amount of the driving current,
wherein the power supply provides the first power voltage in a constant voltage level during a first period from a time point when the second transistor is turned off to a time point when the second transistor is turned on again, in a first mode,
wherein the power supply provides the first power voltage in a pulse width modulation method in which a duty ratio of each of a plurality of pulses gradually increases during a second period from a time point when the second transistor is turned off to a time point when the second transistor is turned on again, in a second mode, and
wherein the second period is longer than the first period.
